(19) United States
(12) Patent Application Publication
(10) Pub. No.: US 2015/0269558 A1
(43) Pub. Date: Sep. 24, 2015

(54) Systems and Methods of SMS Bill Payment Rewards

(71) Applicant: COX COMMUNICATIONS, INC., Atlanta, GA (US)

(72) Inventor: Mamta Basnet, Atlanta, GA (US)

(73) Assignee: COX COMMUNICATIONS, INC., Atlanta, GA (US)

(21) Appl. No.: 14/219,538

(22) Filed: Mar. 19, 2014

(51) Int. Cl. G06Q 20/32; G06Q 30/02; G06Q 20/10

(52) U.S. Cl. CPC G06Q 20/3255; G06Q 20/102; G06Q 30/0222

(57) ABSTRACT

According to example embodiments of the systems and methods of SMS bill payment rewards disclosed herein, a customer receives a bill through Short Message Service (SMS). When the customer receives the bill, she has the option to pay through the phone. If the customer pays the bill through SMS messaging through the phone, she may receive a credit such as a promotional video, as a non-limiting example.

### TECHNICAL FIELD

The present disclosure is generally related to billing services and, more particularly, is related to SMS billing services.

### BACKGROUND

Telecommunications billing may refer to a group of processes of communications service providers that are responsible to collect consumption data, calculate charging and billing information, produce bills to customers, process payments, and manage debt collection. A telecommunications billing system may refer to enterprise application software designed to support the telecommunications billing processes.

Telecommunications billing is a significant component of any commercial communications service provider regardless of specialization: telephone, mobile wireless communication, VoIP companies, mobile virtual network operators, internet service providers, transit traffic companies, cable and satellite TV companies could not operate without billing, because it creates an economic value for the business.

Billing functions can be grouped into three areas: operations, information management, and financial management. Billing and revenue management (BRM) are often considered as a single process bundle, while special functional areas may include revenue assurance, profitability management, and fraud management.

Operations may includes functions of capturing usage records (depending on the industry, these may include call detail records, charging data records, network traffic measurement data, and usage data prepared by telecommunications mediation systems), rating consumption, applying prices, tariffs, discounts, taxes and compiling charges for each customer account, rendering bills, managing bill delivery, applying adjustments, and maintaining of customer account.

Operations implementation may vary significantly depending on communications type and payment model. In particular, for prepaid customers, billing should be realized continuously and when a lower threshold amount at the account is reached, systems may automatically limit a service. In a postpaid service model there are no vital requirements to decrease a balance of a customer account in real time with charging scheduled to be monthly, for example.

Information management area unites functions that responsible to support customer information, product and service data, pricing models, including their possible combinations, as well as billing configuration data, such as billing cycles, schedules, event triggers, bill delivery channels, audit settings, data archiving parameters. Customer information often integrated with customer relationship management system; collaboration with customer can be a function of information management area of billing system or can be completely allocated in CRM.

Financial management area covers functions of payment tracking and processing, mapping correspondence between payments and consumed services, managing credits and debt collections, calculating company taxes. There are heretofore unaddressed needs with previous billing solutions.

### SUMMARY

Example embodiments of the present disclosure provide systems of SMS bill payment rewards. Briefly described, in architecture, one example embodiment of the system, among others, can be implemented as follows: a billing server configured to store a billing database; an encryption device configured to perform an encryption service; and a middleware module configured to construct an SMS message with encrypted billing information.

Embodiments of the present disclosure can also be viewed as providing methods for SMS bill payment rewards. In this regard, one embodiment of such a method, among others, can be broadly summarized by the following steps: requesting cellphone number of a customer; requesting payment account information; sending billing statement in an SMS message; receiving confirmation for payment from the customer; running payment for customer using the payment account; and sending completed payment confirmation to customer by SMS.

### BRIEF DESCRIPTION OF THE DRAWINGS

FIG. 1 is a system diagram of an example embodiment of a system of SMS billing rewards.

FIG. 2 is a system diagram of an example embodiment of the transmission system of the system of FIG. 1.

FIG. 3 is a flow diagram of an example embodiment of a method of SMS billing rewards.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

In a typical company billing system, customers who pay their bill electronically may amount to about 15 percent, for example. The majority of the remaining accounts may be paid by paper bill, for which the company may spend $35,000,000 in paper inserts, and advertisements that go in the bill. Currently, 60% of the population has smart phones, so billing the customer through SMS messages, thereby reducing the billing costs, would be desired. A customer may apply online, over the phone, or at a retail store, among other options. The customer may be asked to enter a cell phone number, and may also be asked to enter a billing method such as a credit card, debit card, ACH, and electronic check, among others.

According to example embodiments of the systems and methods of SMS bill payment rewards disclosed herein, a customer receives a bill through Short Message Service (SMS). When the customer receives the bill, she has the option to pay through the phone. If the customer pays the bill through SMS messaging through the phone, she may receive a credit such as a promotional video, as a non-limiting example. In an example embodiment, the customer can also cancel the service using SMS messaging.

An electronic bill may currently be transmitted through an email, currently an ebill. The customer may visit the company website and sign up. When the customer sets up her profile, the billing is posted by a billing database system module such as Integrated Communications Operations Management System (ICOMS). Presently, the billing information is populated into two databases. One database provides electronic billing support and another (provided by EDS, for example) provides support for paper billing. Both databases may be duplicated into the ICOMS database system so all bill payments show up in the ICOMS system.

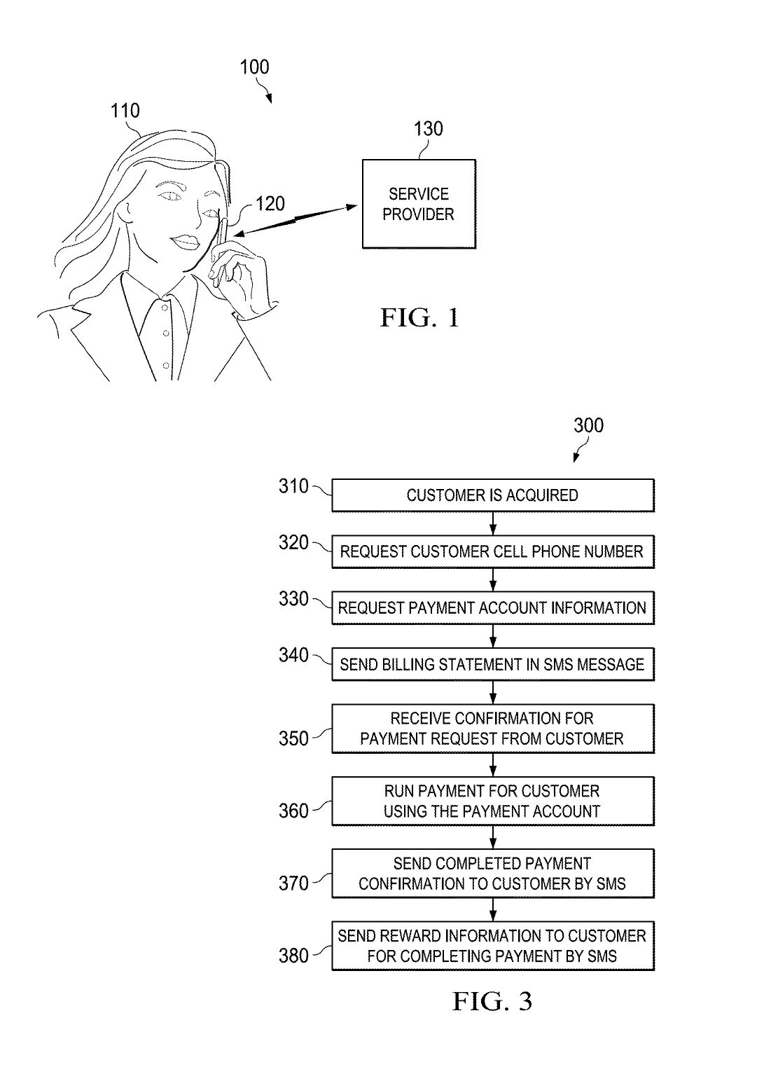

As provided in FIG. 1, in an example embodiment, customer 110 receives a bill from service provider 130 using cell phone 120 as either an attachment to an SMS message or as an SMS message itself containing a summary or a title and then X dollars due at a particular date. There may also be an option to respond with “yes” to the SMS message to have the bill paid. The system will then take the information that has already been loaded in—the credit card information or the echeck information—and the total amount due (or another amount as indicated by the customer) may be charged according to the payment information that is setup in the account. In an example embodiment, a confirmation of the transfer of the payment is sent. If a credit card or a debit card is used, the customer may be directed to enter the 3-digit code on the back of the card for security purposes.

In an exemplary embodiment, customer 110 is acquired online, over phone 120, or at a retail store. Customer 110 is then required to enter a cell phone number for cell phone 120. Service provider 130 then sends a billing statement as an SMS message to the cell phone number listed for that account. Customer 110 also enters a billing method such as credit card or debit card, or electronic check at the time of initial set up. A billing statement will be sent as an SMS message when it is ready. Customer 110 receives the SMS message from the billing statement such as, “Your Cox bill is ready, X dollars are due for payment on MM/DD.” Customer 110 then replies to the SMS.

Alternatively, customer 110 may send a short code SMS to a specific number. The format of the SMS message may be predefined and provided to customer 110 such that the message includes the SMS short code number, the amount, date and action, dollar amount, and submission date in the body. In case the body of the text exceeds 160 characters, multiple SMS messages originating from the same SMS number can be appended by service provider 130. Service provider 130 will then receive the SMS message and bill customer 110 using the credit card or checking account information in the customer profile database. When the payment is processed, service provider 130 may send a confirmation SMS message to customer 110, saying that payment has been applied. If a balance remains, a follow up message may be transmitted with the remaining balance. For example, “Your payment of X dollars has been applied. A remaining balance of Y dollars is due by DD/MM.”

To reward customers for instantaneous action or an action within a certain time period, service provider 130 may also process a credit of X dollars in the customer's billing account and may send an SMS message confirmation, “We have credited X dollars to your billing account for using SMS payment method.” Alternatively, coupons or reward certificates may be awarded upon payment.

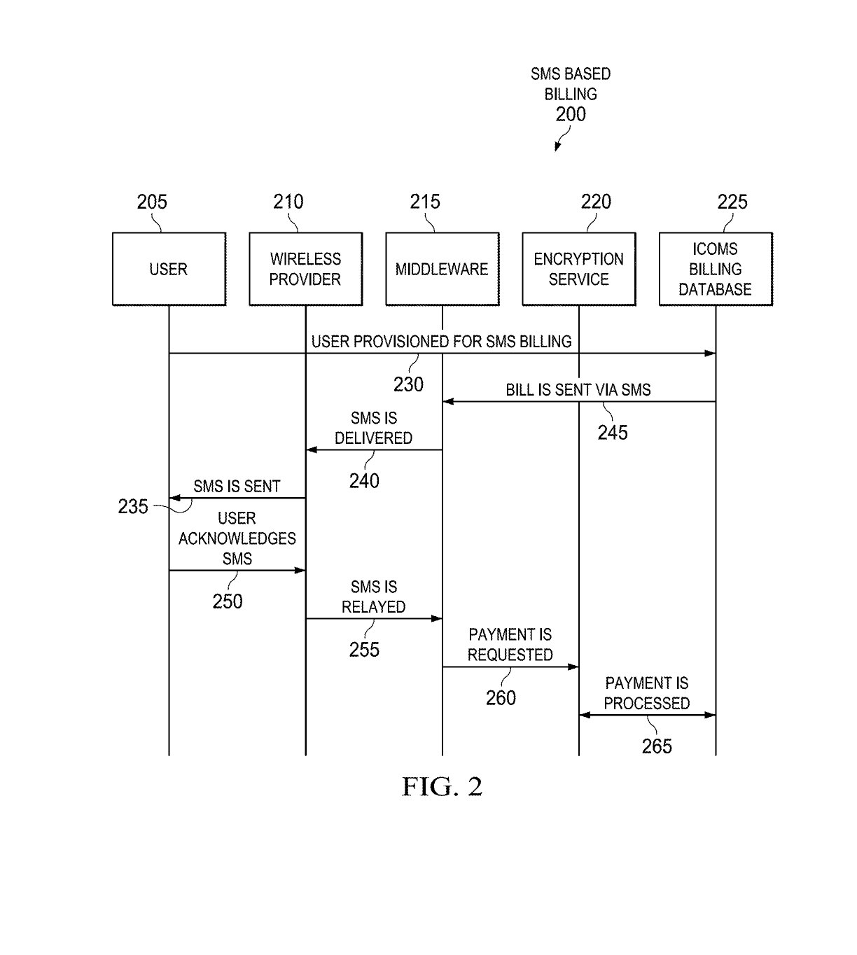

FIG. 2 provides a system diagram of an example embodiment of SMS based billing system 200. In system 200, messages are sent among various elements, including user/customer 205, wireless provider 210, middleware 215, encryption service 220, and ICOMS billing database 225. In action 230, a user is provisioned for SMS billing. When a customer account is set up in ICOMS billing database 225, the account is flagged as eligible for receiving billing notification via SMS. The customer's cellular phone number is also recorded in the account profile. Middleware component 215 may be considered as the broker between billing database 225 and wireless provider 210. In an example embodiment, middleware component 215 receives notification from the billing database 225 when a customer account is ready to be billed and customer 205 is set up to receive billing alerts via SMS. In action 245, billing database 225 provides to middleware component 215 through encryption service 220 at least one of phone number and the SMS body message that includes amount due, due date, etc. Middleware component 215 may subscribe to an intercarrier SMS gateway to send SMS messages. Since this is a system sending SMS messages, intercarrier gateways may allow for transmission of SMS messages by a non-cellular system. In action 240, middleware component 215 middleware component 215 delivers the SMS message to wireless provider 210. In action 235, designated wireless provider 210 transmits the message to end user 205 via SMS.

In action 250, user 205 affirms payment on the account through SMS message by replying with the aforementioned format. In action 255, wireless provider 210 relays the affirmation through SMS back to middleware layer 215. In action 260, middleware layer 215 relays the affirmation back to billing database 225 through encryption service 220. The billing system then processes the payment. In other words, the amount due is charged against the credit card or bank account number stored in the customer profile. The payment is processed and applied to user's billing account. Once the payment processing is complete, in action 265, the billing database 225 sends receipt notification to middleware layer 215. Middleware layer 215 sends the receipt SMS to the customer phone number via wireless provider 210 via the intercarrier gateway. User 205 receives the receipt confirmation and the process is completed.

FIG. 3 provides flow diagram 300 of an example embodiment of a method of SMS bill payment rewards. In block 310, a customer is acquired. In block 320, the customer's cell phone number is requested. In block 330, the customer's payment account information is requested. In block 340, a billing statement is sent to the customer in an SMS message. In block 350, a payment request confirmation message is received from the customer. In block 360, the payment for the customer is processed using the previously provided payment account. In block 370, a completed payment confirmation is sent to the customer by SMS message. In block 380, reward information is sent to the customer for completing the payment by SMS message.

The flow chart of FIG. 3 shows the architecture, functionality, and operation of a possible implementation of the SMS bill payment reward software. In this regard, each block represents a module, segment, or portion of code, which comprises one or more executable instructions for implementing the specified logical function(s). It should also be noted that in some alternative implementations, the functions noted in the blocks may occur out of the order noted in FIG. 3. For example, two blocks shown in succession in FIG. 3 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A method comprising:
requesting cellphone number of a customer;
requesting payment account information;
sending billing statement in an SMS message;
receiving confirmation for payment from the customer;
running payment for customer using the payment account; and
sending completed payment confirmation to customer by SMS.

2. The method of claim 1, further comprising sending reward information to the customer for completing the payment by SMS message.

3. The method of claim 2, wherein the reward information comprises at least one of a monetary award, a discount coupon, and a digital movie pass.

4. The method of claim 1, wherein payment account information comprises at least one of credit card account number, debit card account number, Automated Clearing House (ACH) account information, and bank account information.

5. The method of claim 1, further comprising sending the billing statement as an attachment in an SMS message.

6. The method of claim 1, further comprising sending a summary of the billing statement in the SMS message.

7. The method of claim 6, wherein the summary comprises the amount due and the date due.

8. The method of claim 7, wherein the message further comprises a request for confirmation to pay the amount due.

9. A tangible computer readable medium comprising instructions, the instructions for:
requesting cellphone number of a customer;
requesting payment account information;
sending billing statement in an SMS message;
receiving confirmation for payment from the customer;
running payment for customer using the payment account; and
sending completed payment confirmation to customer by SMS.

10. The computer readable medium of claim 9, further comprising instructions for sending reward information to the customer for completing the payment by SMS message.

11. The computer readable medium of claim 10, wherein the reward information comprises at least one of a monetary award, a discount coupon, and a digital movie pass.

12. The computer readable medium of claim 9, wherein payment account information comprises at least one of credit card account number, debit card account number, Automated Clearing House (ACH) account information, and bank account information.

13. The computer readable medium of claim 9, further comprising instructions for sending the billing statement as an attachment in an SMS message.

14. The computer readable medium of claim 9, further comprising instructions for sending a summary of the billing statement in the SMS message.

15. The computer readable medium of claim 14, wherein the summary comprises the amount due and the date due.

16. The computer readable medium of claim 15, wherein the message further comprises a request for confirmation to pay the amount due.

17. A system comprising:
a billing server configured to store a billing database;
an encryption device configured to perform an encryption service; and
a middleware module configured to construct an SMS message with encrypted billing information.

18. The system of claim 17, wherein the billing server is further configured to initiate the sending of reward information to the customer for completing the payment by SMS message.

19. The system of claim 18, wherein the reward information comprises at least one of a monetary award, a discount coupon, and a digital movie pass.

20. The system of claim 17, wherein the billing server is further configured to initiate the sending of the billing statement as an attachment in an SMS message.
